(19) United States
(12) Patent Application Publication
(10) Pub. No.: US 2005/0111835 A1
(43) Pub. Date: May 26, 2005

(54) Digital video recorder with background transcoder

(76) Inventors: Joseph T. Friel, Ardmore, PA (US); J. William Mauchly, Berwyn, PA (US); Andrew P. Weir, West Chester, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/722,720

(22) Filed: Nov. 26, 2003

(51) Int. Cl. H04N 5/76

(52) U.S. Cl. 386/111; 386/112

(57) ABSTRACT

A Digital Video Recorder is used to record broadcast television programs, store them on a hard disk, and replay them for later viewing. The programs are compressed in the MPEG-2 video compression format when they are first stored on the disk. A separate, second compression algorithm is later performed on the video files that are on the disk. Such transcoding typically occurs when the Digital Video Recorder is otherwise inactive and is used to apply more compression to the stored programs. This step results in a smaller file size for each video file and thereby permits more hours of video to be stored on a given hard disk.

### FIELD OF THE INVENTION

The present invention relates to a digital video recorder that receives and digitally stores television programs for subsequent playback by the user.

### BACKGROUND OF THE INVENTION

The Video Cassette Recorder (VCR) has been popular in homes to record broadcast television shows for later viewing. Recently, the Digital Video Recorder (DVR) (sometimes also called Personal Video Recorder or PVR) has appeared and will probably eventually replace the VCR. For a detailed description of the operation of a typical DVR, see U.S. Pat. No. 6,233,389. While digital video recorders also exist that use tape or removable disks for storage, the popular DVR uses a hard-disk as the mass storage device for the recorded broadcast television signals.

The fixed hard-disk medium has several advantages for recording broadcast television. It is both high capacity and random-access. These features allow it to hold a great number of recorded TV programs and to allow instant access to any one. With a remote control, the user can select, play, pause, fast-forward, rewind, or skip through these programs. Another feature of a hard-disk-based DVR is its ability to automatically record fresh shows while deleting “stale” shows. The random-access nature of the medium allows the device to offer a constantly updated collection of recorded shows, without burdening the user with the need to know where the shows are stored physically or even when they were recorded. Because of all these features, it becomes very desirable to have many hours of recording time. However a main disadvantage of a hard-disk is its fixed size, as compared to a removable storage medium such as a VCR tape. Indeed, the key differentiating feature between different models of DVR is the recording capacity, in particular, the number of hours of video can be stored on the internal hard-disk.

Recording capacity is determined by two things: the size of the hard-disk and the video compression rate. (Audio is assumed to be compressed and stored as well, but audio is an order-of-magnitude smaller than video and, therefore, relatively unimportant.) Today different models are offered with different size hard disks, which directly affect the cost of the units. It is relatively hard to improve the video compression rate. But since large hard-disks are expensive, a way to increase in the video compression rate would be highly valued.

In a DVR, the incoming video is compressed in real-time by the video encoder, and then immediately written to disk. The video compression rate is determined by the format and the quality of the video encoder. Typically, the format is MPEG-2. The MPEG-2 video coding standard (also known as ITU-T H.262) was developed about 1993. It is widely supported; it is used by virtually all digital television broadcasting systems today. The operational details of the MPEG-2 are well known to those skilled in the art and thus will not be elaborated upon here.

In recent years, MPEG-2 has been surpassed by new advances in compression techniques. In particular, the video coding standard known as H.264 (and also as ISO/IEC International Standard 14496-10 (MPEG-4 part 10) Advanced Video Coding) is more efficient than MPEG-2. H.264 can represent video with the same perceived quality and yet at about one-half the bit-rate. This increased compression efficiency comes at the cost of more computation required in the encoder and decoder. Those skilled in the art will appreciate that the H.264 video compression format is much more complex than the MPEG-2 video compression format. The most important new features include:
Variable block-size motion compensation with small block sizes;
Quarter-sample accurate motion compensation;
Motion vectors over picture boundaries;
Multiple reference picture motion compensation;
Weighted prediction;
Improved “skipped” and “direct” motion inference;
Directional spatial prediction for intra coding;
In-the-loop de-blocking filtering;
Hierarchical block transform; and
Content adaptive arithmetic entropy coding.

This complexity directly affects the cost of implementing an encoder. To take advantage of all the different coding options, the H.264 encoder has to test many different combinations of all of these parameters and choose the most efficient one. As a result, the H.264 encoder can require 20 times more computation than an MPEG-2 encoder.

It would be desirable to have a DVR that could use an advanced video codec like H.264 as it would allow more television programs to fit on a given hard-disk. However, the conventional DVR design requires a video encoder that operates in real-time on the incoming video signals. Unfortunately, there are several obstacles that make a real-time H.264 encoding system very expensive:
The high computational resources needed to do H.264 encoding in real-time;
The large amount of memory required to do H.264 encoding in real-time;
The rate at which H.264 encoding proceeds is highly variable, necessitating a large buffer for uncompressed video data;
Still another drawback to using a real-time H.264 is the increased latency for the video to pass through the encoder-decoder chain before being displayed on the TV set.

Thus far, a DVR has been described that receives analog television broadcasts and encodes them into MPEG-2 video. However, a DVR may also bee implemented in a digital set-top box (STB). In this case, the television broadcasts arrive at the STB already encoded in MPEG-2. These programs can be recorded directly to a hard-disk since they are already digitized and compressed. In order to achieve any further compression on these signals, however, they would have to be transcoded to a new format or bit-rate.

Transcoding is defined as a reprocessing of compressed video from one rate to another, and/or from one resolution to another, or from one standard to another. The idea of transcoding the digital signal as it enters the STB has been described by Moroney in U.S. Pat. No. 6,532,593 entitled “Transcoding For Consumer Set-top Storage Application.” Since Moroney performs a transcode operation on data before it is ever stored on a mass storage device, Moroney requires a real-time transcoder. Moroney also focuses on the first and simplest type of transcoding, namely, trancoding from one bit-rate to another in the same format.

Those skilled in the art will appreciate that the concept of transcoding is not new. U.S. Pat. No. 5,617,142, for example, offers an improvement to a transcoder that converts from one rate to another within the same format. Computer programs are known that transcode a video file from one format to another. These programs, which usually operate on PCs, perform file-to-file operations that are not constrained to operate in real-time. For example, the program called Transcode is an open-source project currently available on the Internet at http://www.theorie.physik.uni-goettingen.de/˜ostreich/transcode/. Transcode is a utility that allows conversion from MPEG-2, DV, DivX, or MJPEG into any of the other named video formats. However, such a tool is not applicable to a DVR system, which is a consumer device that is constrained to operate on real-time video input and to provide real-time video output.

A DVR system is desired that maximizes the use of video compression technology within the constraints of a real-time video input and a real-time video output, thereby maximizing the amount of video that may be stored for a given hard-disk size. The present invention addresses this need in the art.

### SUMMARY OF THE INVENTION

The present invention provides a way to employ the advantages of an advanced video codec like H.264 within the real-time constraints of a digital video recorder for recording live broadcast television. The key feature of the invention is a transcoding operation that takes previously compressed video (typically MPEG-2) and compresses it to a smaller size. This operation takes its input from a file and puts its output to a file on a hard-disk, and so is not constrained by the rate of incoming video. This allows the transcode algorithm to use the finite computational resources over a longer period of time, thereby providing greater total computation per second of video. In an exemplary embodiment, the computational power is used to perform the more demanding video compression algorithm of H.264, resulting in a smaller file. Other sophisticated compression algorithms may also be used as desired. The original, larger file is deleted, allowing more room for more video in a given hard-disk.

In practice, the transcoding stage will often take place overnight, or on other off-hours when the DVR is neither recording nor playing back video. In computer terminology this is called a background task. This feature allows a DVR to be implemented with fewer hardware computing resources than one that must record, playback, and transcode simultaneously. In other words, the transcoding stage uses the DVR's hardware resources at a time when they are not otherwise employed. This aspect of the invention takes advantage of the fact that the average viewer will only record or watch 5 hours of video a day, yet the DVR is powered and available 24 hours a day.

In addition, the invention provides a way for digital set-top box that includes a DVR to take advantage of advanced video compression technology. In a digital STB, the programs come into the box already compressed into MPEG-2 format. (The providers cannot switch to H.264 at the head-end. Because of their installed based of STBs, digital satellite and digital cable providers must continue to provide all of their programs in the MPEG-2 format.) With this invention, the STB can convert recorded programs into a more compact format like H.264, and thus provide more total recording space for the user.

### BRIEF DESCRIPTION OF THE DRAWINGS

These and other features and advantages of the invention will be apparent from the following detailed description of exemplary embodiments of the invention, of which:

FIG. 1 is a block diagram illustrating the data flow in a DVR with an analog video input.

FIG. 2 is block diagram illustrating the data flow in the first exemplary embodiment of the invention.

FIG. 3 is a flow chart showing the time sequence of the steps of the invention according to the first exemplary embodiment.

FIG. 4 is a block diagram illustrating the data flow in a DVR with a digital video input and a transcoder.

FIG. 5 is a block diagram illustrating the data flow in the second exemplary embodiment of the invention.

FIG. 6 illustrates the system block diagram for a DVR system that can use a common resource pool to implement different encoders and decoders.

### DETAILED DESCRIPTION OF ILLUSTRATIVE EMBODIMENTS

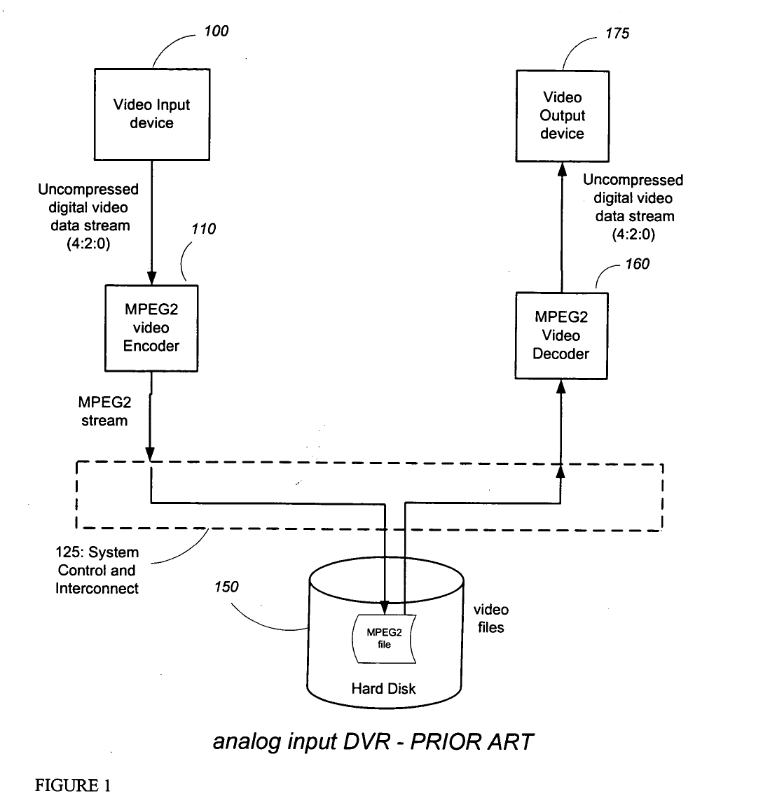

A detailed description of exemplary embodiments of the present invention will now be described with reference to FIGS. 1-6. Although this description provides detailed examples of possible implementations of the present invention, it should be noted that these details are intended to be exemplary and in no way delimit the scope of the invention.

FIG. 1 illustrates system data flow in a prior art digital video recorder with analog video input. The DVR has two main functions: to record video and to playback video. These two operations can happen either separately or simultaneously. The user can choose to playback any file, including the one that is being simultaneously recorded.

The DVR records broadcast television programs. As illustrated, the analog television signal is provided by the video input device 100. In the United States, the analog television signal is encoded in the NTSC format, and the video input device 100 may include a television tuner and an NTSC decoder for decoding the received analog television signal. The NTSC decoder will sample the video at some resolution, for example 544 by 480, and produce an uncompressed digital video data stream of 8-bit sampled YUV data that is in a format called 4:2:0. This signal is fed directly into the MPEG-2 video encoder 110.

The MPEG-2 encoder 110 compresses the video into an MPEG-2 video stream. This stream can be at a fixed or a variable bit rate that is adjustable as a system parameter. Common bit rates are 2, 3, or 4 Mbits per second. These bit rates are small enough to allow the video stream to be written to a hard-disk 150. Reading and writing the disk are managed by a system microprocessor and a dedicated bus for the disk-drive interface, represented by the System Control and Interconnect block 125. The described process results in a file on the hard-disk 150 that contains a compressed recording of a broadcast television program.

The playback of a recorded show is essentially the reverse of this process. The file is read from the hard-disk 150 in small chunks and sent, by way of the system interconnect 125, to a decoder. The MPEG-2 video decoder 160 decodes the bitstream in a manner precisely defined by the MPEG-2 specification. The result is a series of frames of video that are uncompressed but are still digital in the 4:2:0 representation. Finally, the video is passed to the video output device 175 that converts the video into an analog NTSC signal suitable for viewing on a television set or video monitor.

Not shown in FIG. 1 are the remote control and user interface functions, which are a necessary part of a full-function digital video recorder. The invention does not affect these components in any way.

As noted previously, it is always desirable to record at a low bit-rate, which will produce smaller files on the hard-disk. For a given encoder, however, the picture quality degrades as the bit-rate is lowered. This is due to both the limitations of the video coding format (MPEG-2) and the finite resources of the real-time encoder, which is usually a costly component in the system. The system could be improved with the use of a better encoder and decoder such as H.264. For example, the MPEG-2 encoder and decoder could simply be replaced by an H.264 encoder and an H.264 decoder. This should result in a DVR that uses a consistently lower bit-rate and, therefore, can fit more hours of video on the hard-disk. However the cost of providing a real-time H.264 encoder and decoder is quite high, and will probably remain so.

### First Exemplary Embodiment

A first exemplary embodiment of the invention is a stand-alone Digital Video Recorder (DVR) unit for home use. It is an improvement on the prior art just described. This unit is intended to provide a maximum amount of video storage, measured in hours, at a low price. To this aim, the DVR unit is described herein with just the fundamental features of a “personal” video recorder; it is assumed that many other features, such as an electronic programming guide, could be included in such a product, depending on the final price range of the unit.

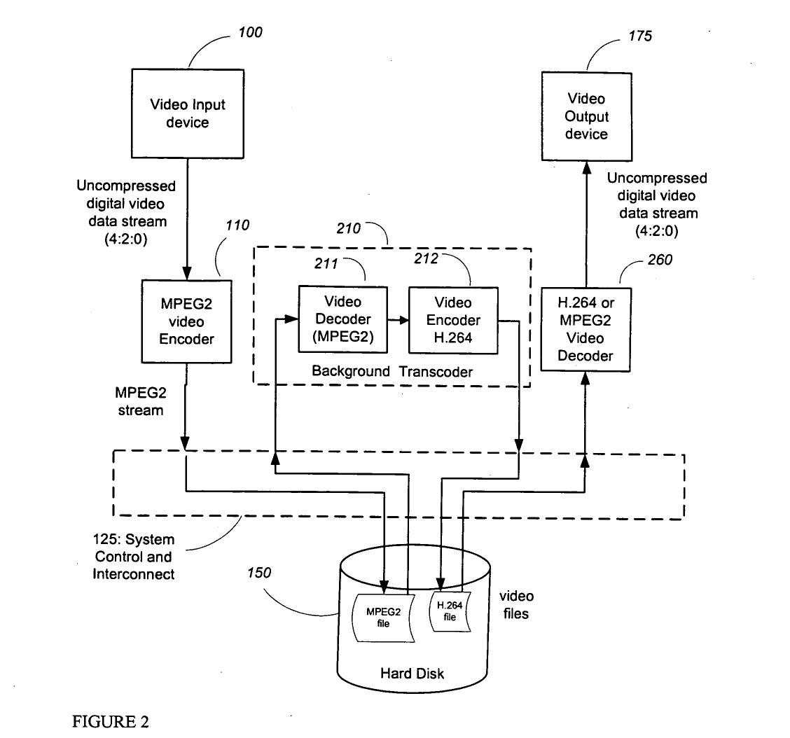

FIG. 2 is a block schematic showing the data flow through the stages of the first exemplary embodiment. As illustrated, television signals enter the system from live broadcast through the video input device 100, which typically includes a TV tuner and an NTSC decoder. The video input device 100 provides uncompressed digital video to the first video encoder (e.g., MPEG-2 encoder) 110. The first video encoder 110 compresses the video to a lower bit rate by encoding according to the MPEG-2 specification. Within that specification there is some leeway regarding which features are used. In a preferred embodiment, a very high fidelity to the original signal is maintained while minimizing the amount of computation in the encoding process. To accomplish this, the bit-rate is reduced to no lower than 6 Mbits per second. This amount of compression is relatively easy to achieve by encoding only I and P frames with zero motion vectors, for it is the search for motion vectors that usually requires the most computation in an MPEG-2 encoder.

The output of the video encoder 110 is written to the hard disk 150 as soon as it is generated. Not shown is the audio portion of the signal, which is also digitized, compressed, and written to disk.

The stored video program can be played back at any time, even while it is being recorded. If the user selects the recorded show at this point, the MPEG-2 stream is read from the hard disk 150 and decoded by the video decoder (e.g., MPEG-2 decoder) 260. The output of the video decoder 260 is an uncompressed digital video data stream in 4:2:0 format which is fed to the video output device 175 for display. The audio portion is also played back in a synchronized fashion.

Whether or not the first pass recording of the video program is viewed, the file containing the stored video program is, in accordance with the invention, scheduled to be re-encoded, or transcoded. This transcoding step is applied to each file, in order, that has been recorded. This transcoding process is also referred to herein as recompression or a second pass in the encode process. The transcoding step may begin whenever there are enough resources available in the system. Since it is a file-to-file operation, there is no restriction on the amount of time, and therefore on the amount of computation, spent to re-encode the file.

The re-encoding step in accordance with the invention reads the MPEG-2 file from the hard-disk 150 and directs it into the background transcoder 210. The transcoder 210 comprises an MPEG-2 video decoder 211 followed by an H.264 video encoder 212. The first (MPEG-2) decoder 211 expands the lightly compressed 6 Mbit/second video stream into uncompressed frames. The output of the decoder 211 is then fed into the encoder 212. In a preferred embodiment, these output frames reside in a DRAM buffer shared by the decoder 211 and the encoder 212. In addition to the video frame data, the decoder 211 may also pass other information that could be of use by the second encoder, such as quantization, motion vector, or cadence information.

This encoder 212 is capable of reducing the video stream to a bit-rate even smaller than that of the encoder 110. In a preferred embodiment, the second encoder 212 produces a file in the H.264 format with a bit rate of about 1 Mbit per second. This new file is written back to disk 150 and the first pass recording is deleted from the disk 150. This completes the transcoding step. Again, this step proceeds at a rate that is not constrained by either real-time input or output. In fact, the key advantage of the invention is that the transcoding will be allowed to spend 4 times longer (in processing) than the playing time of the video.

The user is still free to view the stored video program at any time. If the user selects the show during the transcoding step, the original MPEG-2 file is read from the hard disk 150 and decoded by the video decoder (e.g., MPEG-2 decoder) 260. After the transcoding step is completed, the original MPEG-2 file of that program is deleted. If the user chooses to view the program after the second pass encoding, the H.264 file of that same program is read from the disk 150, decoded by the video decoder 260 and sent to the video output device 175.

### Flow Chart of Operation (First Embodiment)

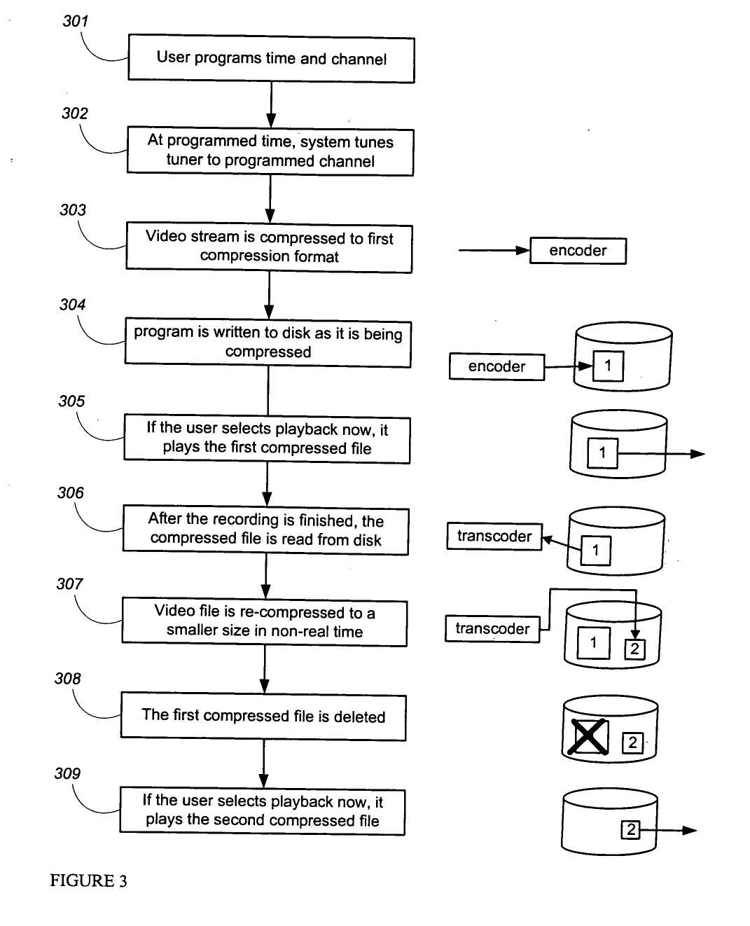

FIG. 3 illustrates the sequence of events that occur in the DVR system of FIG. 2. As is now conventional for VCRs and DVRs, the system is programmed by the user to record television shows at prescribed times. Accordingly, at step 301, the user specifies the time and channel of the show, either directly (using a remote control and an on-screen menu) or indirectly (by identifying the show by name on an on-screen program guide). At the prescribed time, the DVR tunes the tuner to the prescribed television channel and begins the recording process (step 302). The video encoder 110 compresses the incoming video to MPEG-2 in a conventional manner using the video processing resources to provide a first compression (1) at step 303. The compressed video (1) is written to the hard-disk 150 at step 304 as soon as it is generated. Recording proceeds until the video program ends. The user can select to playback the file at anytime, even while it is being recorded. If the user selects playback of compressed video (1) now, the system will play the first compressed file (1) from the disk at step 305.

In accordance with the invention, the system further re-compresses the recording, making the file smaller. Re-compression happens automatically, without any user intervention. Typically this will happen in the middle of the night or at some other time when the recording resources are not being used. Preferably, the system will re-compress at a time when it is neither recording new shows nor playing back recorded shows. The first part of the recompression process is to read the file from disk at step 306. As illustrated at step 307, the second compression stage, or re-compression, creates a file (2) smaller than the original. Unlike the first encoding step 303, step 307 is not bound to finish in real-time, and so it can achieve a superior compression ratio, compared to the first compression step 303. When the system completes the re-compression of a file, it will delete the original first-pass recording of the show and keep the new, smaller version (step 308). The user can still view the recorded program, only now it takes less disk space. The user need not be aware that the transcoding process has taken place. If the user selects playback now, the system will play the second compressed file (2) from the disk at step 309.

### Second Exemplary Embodiment

A second exemplary embodiment includes a digital set-top box (STB) with a built-in hard-disk for video recording in accordance with the techniques of the invention. In such an embodiment, the STB receives a signal that is already compressed into MPEG-2. Because of this, DVR functionality can be added to a STB in a straightforward way. Indeed, most of the DVRs that are available today are built into STBs for either digital-cable or digital-satellite television services. Such a box does not require a video encoder, since the signal is already MPEG-2. This both lowers the price and increases the quality of the DVR recording. This increased quality comes from the fact that the MPEG-2 encoders used at the head-end of the cable or satellite delivery system are very expensive and of very high quality. They achieve a very low bit-rate (compared to consumer MPEG-2 encoders) and a good picture quality.

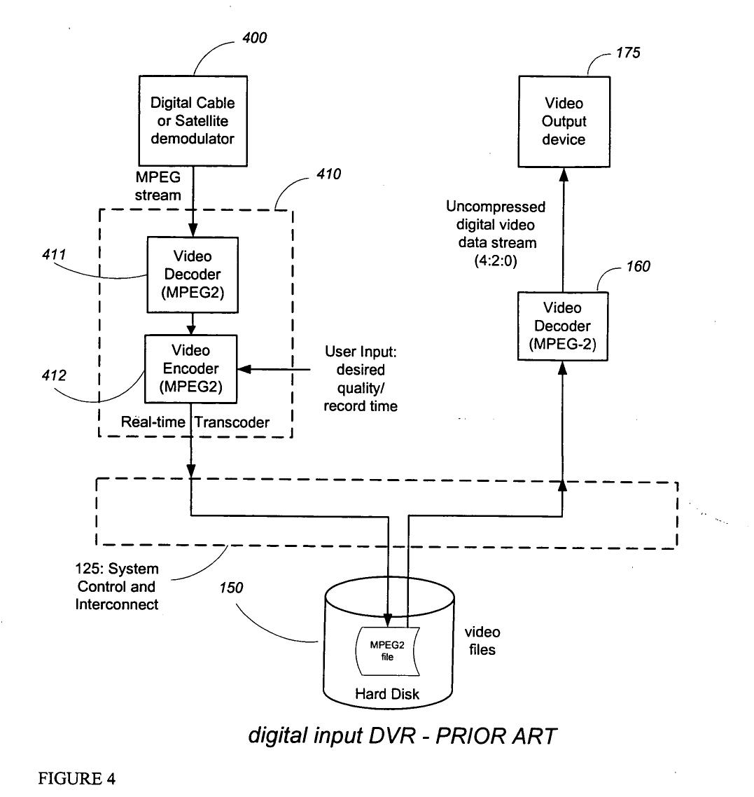

Still, it could be desirable to lower the bit-rate even further for the purpose of recording. The afore-mention Moroney patent identifies the problem: the user would like to lower the bit-rate, but the bit-rate is set at the head-end. To address this need, the Moroney patent suggests the use of an MPEG-2 to MPEG-2 transcoder in the front-end of the STB. A prior art device of this type is illustrated in FIG. 4.

The STB of FIG. 4 includes a digital cable or satellite demodulator 400 that converts the received satellite, cable, or terrestrial broadcast multiplex into an MPEG-2 stream. The MPEG-2 stream, before being recorded, is passed through a real-time transcoder 410. Moroney suggested that this MPEG-to-MPEG transcoder 410 can be constructed economically by not performing a motion search in the MPEG-2 video encoder 412 and only performing a re-quantization function. Since such a function will always degrade the picture quality, it allows for a user parameter to set the degree. As illustrated, the output of the transcoder 410 is an MPEG-2 stream with the same format but a lower bit-rate. The stream is written to a hard-disk 150 immediately.

The remaining components of the digital-input DVR of FIG. 4 are the same as in the analog-input DVR of FIG. 1. With user input, the MPEG-2 file is read from the disk 150, decoded by the MPEG-2 decoder 160, and output through the video output device 175.

As previously noted, the DVR of FIG. 4 performs a transcode operation on data before it is ever stored on a mass storage device, and thus requires a real-time transcoder 410. It also focuses on the first and simplest type of transcoding, from one bit-rate to another in the same format.

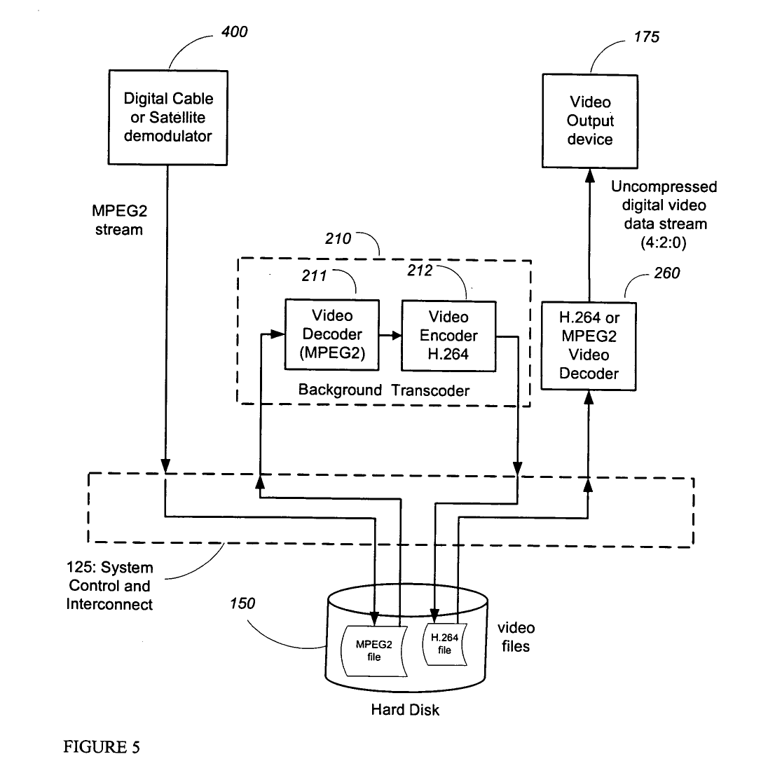

FIG. 5 illustrates second embodiment of the invention. The data flow is substantially the same as in the first embodiment, described above. However, in this embodiment, the video input device is now a digital cable or satellite demodulator 400. As in a conventional digital-input DVR, the inbound MPEG-2 signal is written immediately to disk without further processing. This results in an MPEG-2 file on the hard-disk 150 where the file's size is completely determined by the bit-rate set at the head-end.

The rest of the second embodiment is identical to the first embodiment, described in FIGS. 2 and 3 above. The MPEG-2 file is transcoded into a smaller file in a background process and is stored on the hard disk 150 in place of the MPEG-2 version of the file. Playback of the file proceeds as described above with respect to FIG. 3 and thus will not be described in any further detail.

### Third Exemplary Embodiment

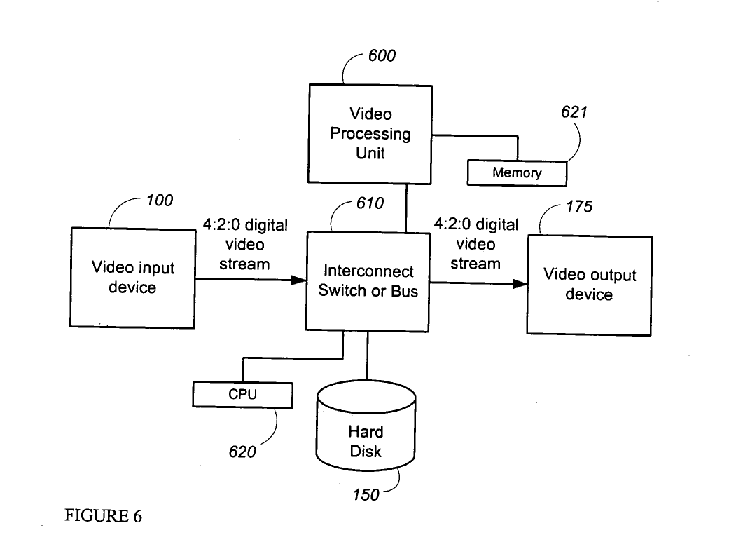

FIG. 6 illustrates a high-level block diagram of a third embodiment of the invention. The main point of this embodiment is that a low-cost system can be constructed by sharing resources between the various logical components. In the first and second embodiments, the flow of data through various processing boxes was illustrated in such a manner that each of these boxes could represent a mathematically defined algorithm. Since any of these algorithms can be implemented as hardware or software or a combination of both, it may be efficient to provide a single pool of computing resources that can accomplish all of the operations.

In FIG. 6 video processing unit 600 contains the computational resources capable of all the video compression and video decompression necessary to implement the first or second embodiment. It is directly connected to a large DRAM memory 621. A system controller, such as CPU 620 controls operation of these devices as well as the storage and playback of the video data to/from hard-disk mass storage device 150 via interconnect switch bus 610.

Generally, it is desired that the computational resources are capable of performing the following tasks, though not necessarily all at the same time:
1. MPEG-2 real-time video encoding;
2. MPEG-2 video decoding and real-time playback;
3. H.264 video encoding;
4. H.264 video decoding and real-time playback;
5. AC3 real-time audio encoding; and
6. AC3 audio decoding and real-time playback.
   Compression Formats and Parameters

Normal interlaced NTSC television can be represented digitally in an uncompressed format called D1. The resolution of the video is 720 by 480 pixels, and it operates at 30 frames or 60 fields per second. Color data is decimated, compared to the luminance information, so that there are two bytes of color for every four bytes of luminance. This color format is called 4:2:0. With these parameters, D1 video occupies about 120 Mbits per second. This corresponds to a recording rate of 900 Mbytes per minute. It is not economical to record long television shows to disk in this format.

A conventional DVR will compress video at 120 Mbits/second to about 3 Mbits/second for a 40:1 compression. This works out to about 1.3 GByte per hour. As a result, a conventional 80 MByte hard disk can hold up to 60 hours of compressed video. In the current invention, the first pass compression will reduce the video to a digital bit-stream of between 3 and 10 Mbits per second. However, in a preferred embodiment, the average bit-rate is 6 Mbits per second. At this bit-rate, the signal will undergo almost no distortion, and will be indistinguishable from the original, to the untrained eye. Such a compression works out to a 20:1 compression and about 2.6 GByte per hour. At this compression rate, a conventional 80 MByte hard disk can hold up to 30 hours of compressed video.

The second compression in accordance with the invention will further reduce the data rate to about 1 Mbit per second. This represents a compression ratio of 120:1 from the original raw video. At this compression rate, a conventional 80 MByte hard disk can hold up to 180 hours of compressed video.

Newly recorded files may temporarily use up a large portion of the available disk space. Eventually these are all re-compressed and more free-space is made available on the disk. The amount of disk space devoted to first and second compressed files can change dynamically with no adverse side effects.

Advantages of Non-Real-Time Compression

As noted above, the second encoder is more complex and uses more computing resources than the first encoder. But the second encoder can operate in non-real-time—that is, it can take longer than a second to compress one second of video. This simple difference will allow the system to achieve a much higher compression ratio than the conventional first pass compression.

There are two main ways that a non-real-time encoder can produce a better (smaller) file than a real-time encoder. First, and most importantly, the non-real-time encoder can perform more computation. For example if a given processor can perform 2 billion operations per second, then in four seconds it can do as much work as a processor that does 8 billion operations per second, if that processor had to complete the job in one second. Real-time encoders have to completely finish on-time because new video is continuously streaming into it.

The second advantage of a non-real-time encoder is its ability to “see” a longer sequence of video frames. This can allow more sophisticated analysis and pre-processing of the video, such as:
Look-ahead detection of scene change and edit points;
Look-ahead detection of black frames, fade-ins and fade-outs;
Detection of 3:2 pulldown;
Pre-processing: noise reduction, filtering, de-interlacing, scaling.

As noted above, the H.264 compression standard has an increased complexity, compared to MPEG-2, which demands more computational power. Mainly, it allows a number of different coding modes on any given block. The encoder must evaluate each of these different modes to determine the most efficient one. This is in addition to motion search, which is also expensive computationally because so many different frames need to be searched. To do a good job, an H.264 encoder integrated circuit would have to be considerably more powerful, and therefore more expensive, than an MPEG-2 encoder. By being free from real-time constraints, the transcoder in the current invention can be implemented with a processor of one-fourth the power and cost of a real-time implementation.

An important operating parameter in accordance with the invention is the transcode run time. Under typical usage, it is estimated that the DVR will record between 2 and 5 hours of television programming a day. The DVR should run the transcoder on most of this data within 24 hours, in order to free up the first pass buffer. Accordingly, the transcoder should take no longer than 20 hours to re-compress 5 hours of video.

An additional advantage of the non-real-time transcoder process is that it can borrow processing resources that are not being used by other parts of the system, as discussed in the third embodiment. When the system is not recording or not playing or not doing either task, all those computational resources are available to be re-used.

Recompression Scheduler

The invention may also include a scheduling algorithm that controls when the DVR will perform recompression, and which files it will work on.

In accordance with the invention, the transcoding process should be automatic. No user input is needed for the system to transcode a file that has been recorded. This is in contrast to the prior art system of FIG. 4, which requires that the user set a parameter which controls the desired quality versus record-time. In the system of FIG. 4, the parameter is set before the broadcast is recorded, and the transcoding takes place immediately, as soon as the stream hits the set-top box and before it ever goes to the hard disk. In that case, the user is given a choice because the transcoder is always creating a file of lesser quality, and the user must specify the degree to which he will allow degradation. In the current invention, the user is unaware of the transcoding process, and consistent quality will be maintained. The decreased file size is achieved by utilizing a superior compression format and by spending greater computational power on the encoding, not by compromising the video quality.

The preferred embodiment allows both the first and second encoder to share the same computational resources. This can cause a resource conflict. A policy must be enforced to deal with this problem.

The recompression is implemented as a low-priority task in a multi-tasking operating system. The other tasks are the recording task and the playback task, and these two have higher priority. In other words, record and playback will always get all the resources they need to be able to run and function perfectly. Since it has lower priority, the recompression task will drop back to using fewer, or possibly no resources, as necessary. This structure will allow the resources of the system to be used to maximum efficiency. For example, when the system determines that it is time to record a television show, it activates the record task. This task takes whatever system resources it needs to run (the tuner, the NTSC decoder, the MPEG-2 encoder, some memory and some disk drive bandwidth.) Whatever resources are left over can still be used by the lower-priority recompression task, which will now get less work done because it has fewer computing resources.

The second scheduling issue is to determine which files are recompressed. Typically, the files are recompressed in the order that they are recorded. This simple idea can be implemented by having the system, when it is time to choose a file to recompress, search for the oldest file that has not been recompressed.

A more sophisticated algorithm can be applied if the system can predict when a recording will be deleted. There are several cases where this is true. For example in the TiVo system, the user can specify a “save until” date for each specific recording. If a delete date is not specified, the DVR will delete shows as needed to make room for new recordings. It can predict, since it knows when it is going to make new recordings, when it is going to delete a given file. If the system has this feature, then the recompression schedule algorithm can be smart about not recompressing files that are slated to be deleted soon anyway. It is more effective to recompress files that are going to sit on the disk for a long period of time.

Those skilled in the art will appreciate that the primary advantage to the method of the invention is that the re-encoding can make a smaller file for a given picture quality. Smaller files allow more hours of video to be stored on a given size hard-disk. Also, the method of the invention allows implementation of the DVR with less hardware (silicon area) than a real-time transcoder. Again, there are two reasons for this savings: the second pass encode could reuse the same hardware resources as the first pass, and the second pass is not constrained to be real-time so that it can use the resources over a longer period of time.

From the above description, it should be readily apparent that numerous other modifications and combinations of the above disclosure may be made without departing form the scope of the present invention. For example, other compression techniques besides H.264 coding may be used in accordance with the invention. It is envisioned that the invention will incorporate more advanced compression techniques as they become available. The invention may also have other applications. For example, the DVR may include a removable digital media such as a writable DVD and the recompression is designed to fit this recorded program onto the removable digital media. Also, the DVR may include a removable hard drive as the storage device that is connected via USB2 to the processing components. Accordingly, the processes described herein are intended as specific implementations only and are not intended to delimit the scope of the invention, which should instead be understood with reference to the following claims.

1. A process for the recording, storage, and playback of video data, comprising the steps of:
receiving broadcast video data;
encoding, using a first compression format, said video into a first encoded file;
storing said first encoded file on a storage device;
retrieving said first encoded file from the storage device;
re-encoding said first encoded file, using a second compression format, to create a second encoded file, wherein said second encoded file is smaller than said first encoded file;
storing said second encoded file on the storage device; and
decoding the second encoded file for playback.

2. The process of claim 1, wherein said first compression format is MPEG-2.

3. The process of claim 1, wherein said second compression format is H.264.

4. The process of claim 1, wherein encoding using said first compression format is performed substantially in real-time and encoding using said second compression format is performed in non-real-time.

5. The process of claim 1, wherein said re-encoding step uses some of the same processing resources that would have been used by the first encoding step if broadcast video data were being encoded or resources that would have been used by the decoding step when a file was being played back.

6. The process of claim 1, wherein a plurality of first encoded files are stored on said storage device and said re-encoding step includes the step of re-encoding said plurality of first encoded files into second encoded files in the order in which said first encoded files were recorded.

7. A process for the recording, storage, and playback of video data, comprising the steps of:
receiving digital video data encoded using a first compression format;
storing said received digital video data in a first encoded file on a storage device;
retrieving said first encoded file from the storage device;
re-encoding said first encoded file, using a second compression format, to create a second encoded file, wherein said second encoded file is smaller than said first encoded file;
storing said second encoded file on the storage device; and
decoding the second encoded file for playback.

8. The process of claim 7, wherein said first compression format is MPEG-2.

9. The process of claim 7, wherein said second compression format is H.264.

10. The process of claim 7, wherein encoding using said second compression format is performed in non-real-time.

11. The process of claim 7, wherein a plurality of first encoded files are stored on said storage device and said re-encoding step includes the step of re-encoding said plurality of first encoded files into second encoded files in the order in which said first encoded files were recorded.

12. A digital video recorder for recording, storing, and playing back video data, comprising:
a video input device that receives broadcast video data;
a first encoder that encodes, using a first compression format, said video into a first encoded file;
a storage device that stores said first encoded file;
a second encoder that re-encodes said first encoded file, using a second compression format, to create a second encoded file, wherein said second encoded file is smaller than said first encoded file; and
a decoder that decodes the second encoded file for playback.

13. The digital video recorder of claim 12, wherein said first encoder comprises an MPEG-2 format codec.

14. The digital video recorder of claim 12, wherein said second encoder comprises an H.264 format codec.

15. The digital video recorder of claim 12, wherein said storage device is a hard disk.

16. The digital video recorder of claim 12, wherein said first encoder and second encoder share data processing resources.

17. The digital video recorder of claim 12, further comprising a scheduler that schedules said second encoder to compress said first encoded file into said second encoded file when no broadcast video data is being received.

18. The digital video recorder of claim 17, wherein a plurality of first encoded files are stored on said storage device and said scheduler schedules re-encoding of said plurality of first encoded files into second encoded files in the order in which said first encoded files were recorded.

19. The digital video recorder of claim 12, wherein said storage device comprises a removable digital media and said second encoder re-encodes said first encoded file so that content of said first encoded file will fit onto the removable digital media.

20. A digital video recorder for recording, storing, and playing back video data, comprising:
a video input device that receives digital video data encoded using a first compression format;
a storage device that stores said received digital video data as a first encoded file;
an encoder that re-encodes said first encoded file, using a second compression format, to create a second encoded file, wherein said second encoded file is smaller than said first encoded file; and
a decoder that decodes the second encoded file for playback.

21. The digital video recorder of claim 20, wherein said encoder comprises an H.264 format codec.

22. The digital video recorder of claim 20, wherein said storage device is a hard disk.

23. The digital video recorder of claim 20, wherein a plurality of first encoded files are stored on said storage device, further comprising a scheduler that schedules re-encoding of said plurality of first encoded files into second encoded files in the order in which said first encoded files were recorded.

24. The digital video recorder of claim 20, wherein said storage device comprises a removable digital media and said encoder re-encodes said first encoded file so that content of said first encoded file will fit onto the removable digital media.
